(19) United States
(12) Patent Application Publication
(10) Pub. No.: US 2012/0169445 A1
(43) Pub. Date: Jul. 5, 2012

(54) TRANSFORMER AND FLAT PANEL DISPLAY DEVICE HAVING THE SAME

(75) Inventors: Jae Hyun Lee, Yongin (KR); Choong Sik Yoo, Yongin (KR); Young Chang Choi, Suwon (KR); Yo Sung Myoung, Suwon (KR); Myeong Sik Cheon, Suwon (KR)

(73) Assignee: SAMSUNG ELECTRO-MECHANICS CO., LTD., Suwon (KR)

(21) Appl. No.: 13/337,730

(22) Filed: Dec. 27, 2011

(30) Foreign Application Priority Data
Dec. 30, 2010 (KR) 10-2010-0139236

(51) Int. Cl. H01F 17/04; H01F 27/29

(52) U.S. Cl. 336/105; 336/192

(57) ABSTRACT

There are provided a transformer and a flat panel display device having the same. The transformer includes: a bobbin, around which a coil is wound; and an input/output terminal installed in the bobbin, a lead portion of the coil wound around the bobbin being connected to the input/output terminal, wherein the input/output terminal has a stopper portion protruded from at least one face and limiting a winding position of the coil such that the lead portion of the coil is wound therearound to be separated from the bobbin.

### CROSS-REFERENCE TO RELATED APPLICATIONS

This application claims the priority of Korean Patent Application No. 10-2010-0139236 filed on Dec. 30, 2010, in the Korean Intellectual Property Office, the disclosure of which is incorporated herein by reference.

### BACKGROUND OF THE INVENTION

1. Field of the Invention

The present invention relates to a transformer and a flat panel display device having the same, and more particularly, to a transformer mounted on a circuit board and regulating an output voltage according to a desired voltage, and a flat panel display device having the same.

2. Description of the Related Art

Recently, in the area of displays, a new technology flat panel display (FPD), appropriate for a multimedia system having features such as high resolution, a large screen, or the like, in place of cathode ray tubes (CRTs), has come to prominence.

In particular, in large-scale displays, thin display panels, such as a liquid crystal display (LCD) TV or a plasma display panel (PDP) TV, have come to prominence and have been expected to continuously receive attention in terms of cost and marketability in the future.

Among thin display panels, LCD TVs have employed a cold cathode fluorescent lamp (CCFL) as a light source of a backlight, but recently, they have increasingly use a light emitting diode (LED), rather than the CCFL, due to various advantages of the LED, such as low power consumption, a long lifespan, environmental-friendliness (or eco-friendly characteristics), and the like.

The use of an LED enables a reduction in the size of a backlight unit, which leads to a reduction in the thickness of a flat TV. Also, slimness in an internal power supply module of the flat TV is accordingly required.

Meanwhile, a transformer includes a plurality of input/output terminals installed to be protruded from a bobbin and mounted on a circuit board, and coils wound around the bobbin are fixedly installed with the input/output terminals. Namely, the coils are fixed to each of the plurality of input/output terminals through a soldering process.

However, the coils wound around the input/output terminals are wound such that they are disposed to be adjacent to the bobbin. Thus, the bobbin may be deformed by a soldering solution (i.e., molten lead) or the coils wound adjacent to the bobbin may not be soldered in the soldering process.

### SUMMARY OF THE INVENTION

An aspect of the present invention provides a transformer capable of reducing a phenomenon in which a bobbin is thermally deformed during a soldering process and reducing defective soldering caused as a wound coil is not soldered, and a flat panel display device having the same.

According to an aspect of the present invention, there is provided a transformer including: a bobbin, around which a coil is wound; and an input/output terminal installed in the bobbin, a lead portion of the coil wound around the bobbin being connected to the input/output terminal, wherein the input/output terminal has a stopper portion protruded from at least one face and limiting a winding position of the coil such that the lead portion of the coil is wound therearound to be separated from the bobbin.

The bobbin may have a terminal installation portion extending to be protruded from one end thereof to allow the input/output terminal to be installed therein.

The input/output terminals may include a horizontal portion installed in the terminal installation portion such that the horizontal portion is parallel to the terminal installation portion, and a bent portion extending from the horizontal portion.

The stopper portion may extend from respective outer faces of the horizontal portion, may be disposed to be perpendicular to the horizontal portion, and may have any one of a circular shape, a quadrangular shape, and a polygonal shape.

The stopper portion may be formed as a projection extending from both side faces of the horizontal portion.

The bobbin may include inner and outer bobbins, each having an annular body part having a through hole therein and a flange portion protruded from the body part to an opposite side of the through hole.

The inner bobbin may be inserted into the through hole of the outer bobbin so as to be coupled to the outer bobbin such that at least one of an upper surface of the flange portion of the inner bobbin and an upper surface of the flange portion of the outer bobbin, and a lower surface of the flange portion of the inner bobbin and a lower surface of the flange portion of the outer bobbin are disposed to be parallel to each other.

A width of the flange portion of at least one of the inner and outer bobbins may be greater than the thickness of the body part.

The coil wound around the bobbin may include a primary coil wound around the inner bobbin and a secondary coil wound around the outer bobbin, and at least one of the primary coil and the secondary coil may include a plurality of coils electrically insulated from each other.

According to another aspect of the present invention, there is provided a flat panel display device including: a power supply unit including the foregoing transformer mounted on a substrate; a display panel receiving power from the power supply unit; and a cover protecting the display panel and the power supply unit.

A coil wound in the transformer may be wound to be parallel to the substrate of the power supply unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a transformer according to an embodiment of the present invention;

FIG. 2 is an exploded perspective view of the transformer according to an embodiment of the present invention;

FIG. 3 is a cross-sectional view of the transformer according to an embodiment of the present invention;

FIG. 4 is an enlarged view of portion A of FIG. 1;

FIG. 5 is a perspective view showing an input/output terminal according to another embodiment of the present invention;

FIGS. 6 and 7 are perspective views showing an input/output terminal according to still other embodiments of the present invention; and

FIG. 8 is an exploded perspective view of a flat panel display device according to an embodiment of the present invention.

### DETAILED DESCRIPTION OF THE PREFERRED EMBODIMENT

Embodiments of the present invention will now be described in detail with reference to the accompanying drawings. The invention may however be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

In describing the present invention, if a detailed explanation for a related known function or construction is considered to unnecessarily divert from the gist of the present invention, such explanation has been omitted but would be understood by those skilled in the art.

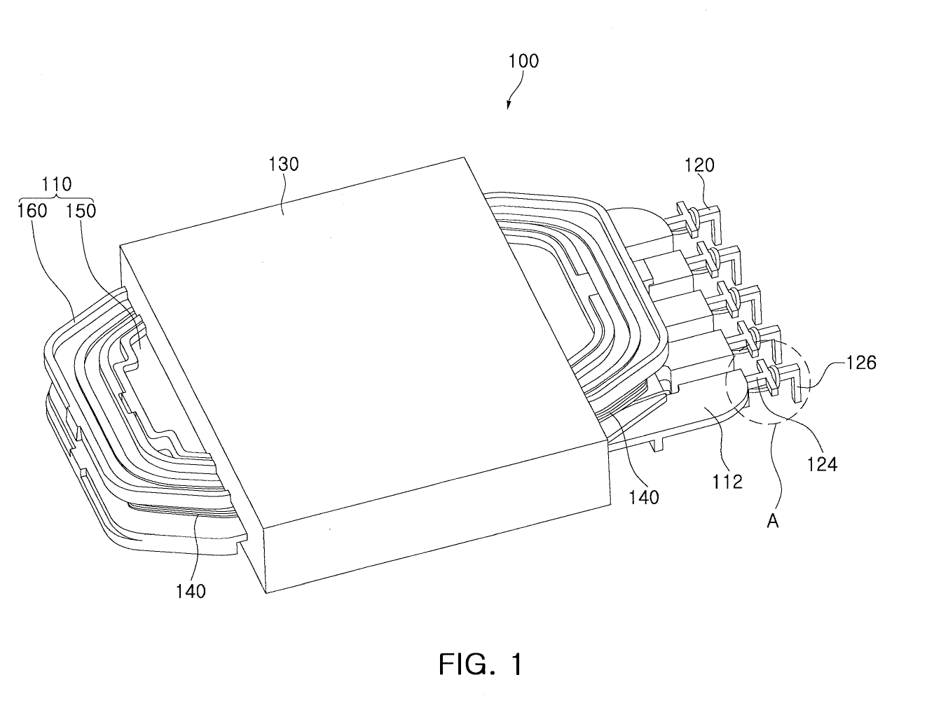

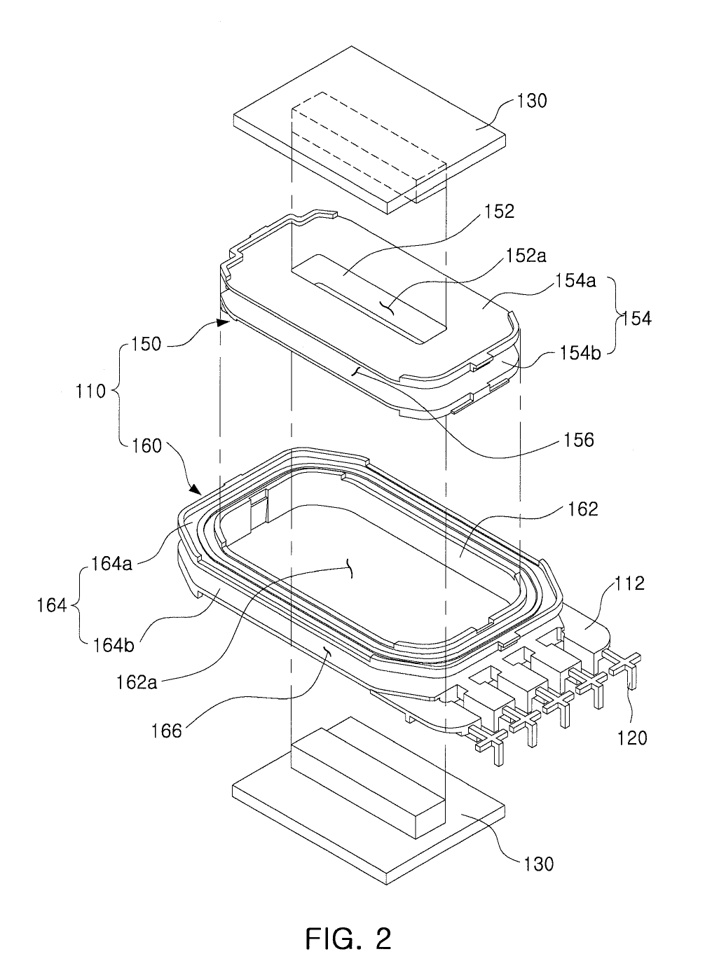

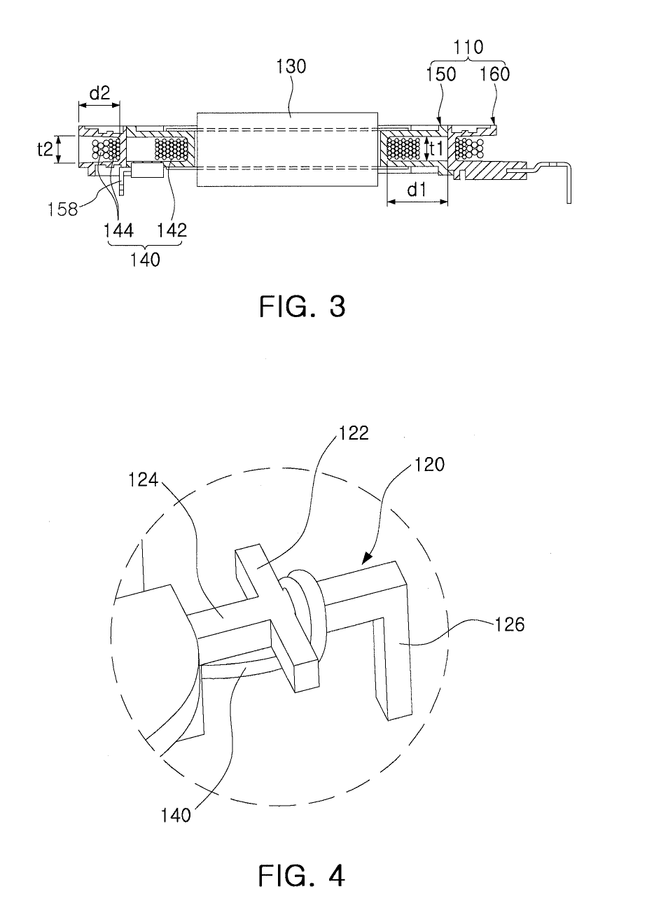

FIG. 1 is a perspective view of a transformer according to an embodiment of the present invention. FIG. 2 is an exploded perspective view of the transformer according to an embodiment of the present invention. FIG. 3 is a cross-sectional view of the transformer according to an embodiment of the present invention. FIG. 4 is an enlarged view of portion A of FIG. 1.

With reference to FIGS. 1 through 4, a transformer 100 according to an embodiment of the present invention may be configured to include a bobbin 110, input/output terminals 120, and a core 130.

Coils 140 are wound around the bobbin 110. The bobbin 110 may include a terminal installation portion 112 extending to be protruded from one end of the bobbin 110. The input/output terminals 120 are installed in the terminal installation portion 112.

The bobbin 110 may be configured to include an inner bobbin 150 and an outer bobbin 160 including annular body parts 152 and 162 having through holes 152a and 162a therein and flange portions 154 and 164 protruded from the body parts 152 and 162 toward the opposite side of the through holes 152a and 162a, respectively.

The inner bobbin 150 is inserted into the through hole 162a of the outer bobbin 160 so as to be coupled to the outer bobbin 160 such that at least one of an upper surface of the flange portion 154 of the inner bobbin 150 and an upper surface of the flange portion 164 of the outer bobbin 160, and a lower surface of the flange portion 154 of the inner bobbin 150 and a lower surface of the flange portion 164 of the outer bobbin 160 are disposed to be parallel to each other.

The terminal installation portion 112 extends to be protruded to the outside from a lower end portion of the outer bobbin 160, and the input/output terminals 120 are fixedly installed in the terminal installation portion 112.

First, the inner bobbin 150 will now be described. As mentioned above, the inner bobbin 150 may include the body part 152 and the flange portion 154 as described above.

The through hole 152a formed in an inner side of the body part 152 serves as a passage allowing the core 130 to be inserted therethrough. Meanwhile, the through hole 152a formed in the body part 152 may have a shape corresponding to the shape of the core 130.

In the present embodiment, the through hole 152a has, for example, a quadrangular shape, but the present invention is not limited thereto, and the through hole 152a may have a circular or polygonal shape.

The flange portion 154 includes an upper flange portion 154a and a lower flange portion 154b. A space formed by the upper flange portion 154a, the lower flange portion 154b, and the body part 152 is used as an inner winding portion 156 around which the coils 140 are wound.

Namely, the flange portion 154, including the upper flange portion 154a and the lower flange portion 154b may serve to support the coils 140 wound around the inner winding portion 156 at both sides thereof and at the same time, may protect the coils 140 against the exterior and secure insulating characteristics between the exterior and the coils 140.

Meanwhile, inner faces of the flange portion 154, namely, a lower face of the upper flange portion 154a and an upper face of the lower portion 154b (in other words, faces forming the inner winding portion 156) may be formed to be inclined. Accordingly, the flange portion 154 has a thickness which is reduced in the outer diameter direction.

Furthermore, in the inner bobbin 150, a width of the flange portion 154 may be greater than a thickness of the body part 152. Namely, a distance d1 between the upper flange portion 154a and the lower flange portion 154b of the flange portion 154 may be greater than a thickness t1 of the body part 152. Accordingly, an output voltage in the thin transformer 100 may be secured.

Here, the width of the flange portion 154 refers to a horizontal distance from an inner face of the through hole 152a of the body part 152 to an edge of the flange portion 154.

Similarly to the inner bobbin 150, the outer bobbin 160 may include the body part 162 and the flange portion 164.

The through hole 162a formed in the interior of the body part 162 serves as a passage allowing the inner bobbin 150 to be inserted therethrough. Meanwhile, the through hole 162a formed in the body part 162 may have a shape corresponding to that of the inner bobbin 150.

In the present embodiment, for example, the through hole 162a has a quadrangular shape, but the present invention is not limited thereto and the shape of the through hole 162a may be variably changed according to the shape of the inner bobbin 150.

The flange portion 164 includes an upper flange portion 164a and a lower flange portion 164b. A space formed by the upper flange portion 164a, the lower flange portion 164b, and the body part 162 is used as an outer winding portion 166 around which the coils 140 are wound.

Namely, the flange portion 164 including the upper flange portion 164a and the lower flange portion 164b may serve to support the coils 140 wound around the outer winding portion 166 at both sides thereof, and at the same time, may protect the coils 140 against the exterior and secure insulating characteristics between the exterior and the coils 140.

Meanwhile, inner faces of the flange portion 164, namely, a lower face of the upper flange portion 164a and an upper face of the lower flange portion 164b (in other words, faces forming the outer winding portion 166) may be formed to be inclined. Accordingly, the flange portion 164 has a thickness which is reduced in the outer diameter direction.

Furthermore, in the outer bobbin 160, a width of the flange portion 164 may be greater than a thickness of the body part 162. Namely, a distance d2 between the upper flange portion 164a and the lower flange portion 164b of the flange portion 164 may be greater than a thickness t2 of the body part 162. Accordingly, an output voltage in the thin transformer 100 may be secured.

Here, the width of the flange portion 164 refers to a horizontal distance from an inner face of the through hole 162a of the body part 160 to an edge of the flange portion 164.

Meanwhile, the bobbin 110 may be manufactured through injection-molding, and may be made of an insulating resin material. The bobbin 110 may be made of a material having high heat resistance and high voltage resistance. For example, polyphenylene sulfide (PPS), liquid crystal polyester (LCP), polybutylene terephthalate (PBT), polyethylene terephthalate (PET), a phenolic resin, or the like, may be used as the material of the bobbin 110.

The input/output terminals 120 are installed in the bobbin 110, and lead portions of the coils 140 wound around the bobbin 110 are connected to the input/output terminals 120. In other words, the input/output terminals 120 are fixedly installed in the terminal installation portion 112 extending to be protruded from one end portion of the bobbin 110.

The input/output terminals 120 may include stopper portions 122, each being protruded from at least one face and limiting a winding position of the lead portion of the coil 40 such that the lead portion of the coil 140 is wound to be separated from the bobbin 110.

The input/output terminals 120 may include horizontal portions 124 and bent portions 126, each horizontal portion being installed in the terminal installation portion 112 in such a manner as to be parallel to the terminal installation portion 112, and each bent portion 126 extending from the horizontal portion 124.

Namely, the stopper portions 122 may be projections extending from both side faces of the horizontal portions 124.

In the embodiment, for example, the stopper portions 122 extend from both side faces of the horizontal portions 124, but the present invention is not limited thereto and the stopper portions 122 may extend from one side faces of the horizontal portions 124.

In this manner, the input/output terminals 120 include the stopper portions 122, and the lead portions of the coils 140 wound around the bobbin 110 may be separated from the bobbin 110 and wound at outer sides of the stopper portions 122.

Thereafter, the input/output terminal 120 may be immersed in a soldering solution (i.e., molten lead) in order to fixedly connect the coils 140 wound at the outer sides of the stopper portions 122 and the input/output terminals 120 in a soldering process.

Here, the soldering solution may not rise toward the bobbin 110 any further due to the presence of the stopper portions 122. Accordingly, the bobbin 110 may be prevented from being thermally deformed by the soldering solution.

In addition, since the lead portions of the coils 140 are separated from the bobbin 110 and wound on the input/output terminals 120, the lead portions of the coils 140 and the input/output terminals 120 may be immersed in the soldering solution with a sufficient depth.

Accordingly, a defect caused with the soldering solution being not applied to the lead portions of the coils 140 may be reduced.

The core 130 may be inserted into the through hole 152a formed in the inner side of the inner bobbin 150. According to the embodiment, the core 130 may include a pair of cores, and the pair of cores may be individually inserted through the through hole 152a of the inner bobbin 150 and be coupled in such a manner as to face each other. The core 130 may include a combined body of an E-shaped upper core and an E-shaped lower core, a combined body of an E-shaped upper core and an I-shaped lower core, or the like.

The cores 130 may be made of Mn—Zn-based ferrite having high permeability, low loss, high saturation magnetic flux density, and stability, and incurring low production costs, compared with other materials.

The coils 140 may include a primary coil 142 wound around the inner bobbin 150 and a secondary coil 144 wound around the outer bobbin 160. At least one of the primary coil 142 and the secondary coil 144 may include a plurality of coils electrically insulated from each other.

In detail, the primary coil 142 may be wound around the inner winding portion 156 formed in the inner bobbin 150.

Also, the primary coil 142 may include a plurality of primary coils electrically insulated from each other within the single inner winding portion 156. In the embodiment, for example, the primary coil 142 is a single coil, but the present invention is not limited thereto.

Namely, in the transformer 100 according to the embodiment, the primary coil 142 may include a plurality of primary coils and various voltages may be applied thereto, and various voltages may be drawn out through the corresponding secondary coil 144.

When the primary coil 142 includes a plurality of primary coils, each of the primary coils may have a different thickness and may have a different number of windings.

Meanwhile, as the primary coil 142, a single strand of wire may be used, or Ritz wire formed by twining several strands of wire may also be used.

The primary coil 142 may be connected to an outer connection terminal 158 where a lead wire is provided in the inner bobbin 150.

The secondary coil 144 may be wound around the outer winding portion 166 formed in the outer bobbin 160.

Similarly to the primary coil 142, the secondary coil 144 may also include a plurality of secondary coils electrically insulated from each other, which is exemplarily illustrated in FIG. 3. Lead wires of the plurality of the secondary coils 144 may be connected to the input/output terminals 120 provided at the outer bobbin 160.

Meanwhile, in the embodiment, as described above, for example, the primary coil 142 is wound around the inner winding portion 156 and the secondary coil 144 is wound around the outer winding portion 166. However, the present invention is not limited thereto, and the primary coil 142 may be wound around the outer winding portion 166 while the secondary coil 144 may be wound around the inner winding portion 156. Namely, various applications may be made so long as a user can draw out a desired voltage.

As described above, since the winding position at which the lead portion of the coil 140 is wound is separated by a certain distance from the bobbin 110 by the stopper portion 122, deformation of the bobbin 110 due to the soldering solution may be prevented and a generation of a soldering defect caused as the coil 140 is not immersed in the soldering solution may be reduced.

Namely, the secondary coil 144 of the coil 140 is wound at the outer side of the stopper portion 122 of the input/output terminal 120 and then soldered, whereby the soldering solution (i.e., molten lead) may not rise any further toward the bobbin 110 during the soldering process due to the stopper portion 122.

Accordingly, a thermal deformation of the bobbin 110 due to the soldering solution may be reduced.

Also, since the secondary coil 144 is wound at the outer side of the stopper portion 122 of the input/output terminal 120 and immersed in the soldering solution, a generation of a defect caused in the case that the soldering solution is not applied to the lead portion of the secondary coil 144 wound around the input/output terminal 120 may be reduced.

Meanwhile, in the present embodiment, for example, the input/output terminals 120 are provided on the outer bobbin 160, but the present invention is not limited thereto, and the input/output terminals 120 including the stopper portions 122 may also be provided on the inner bobbin 150.

Namely, in the present embodiment, for example, the outer connection terminal 158 is installed in the inner bobbin 150, but the present invention is not limited thereto, the input/output terminals 120 including the stopper portions 122 may be installed in the inner bobbin 150.

Input/output terminals according to another embodiment of the present invention will now be described with reference to the accompanying drawings. Here, the same reference numerals of the components as described above will be used in the following description.

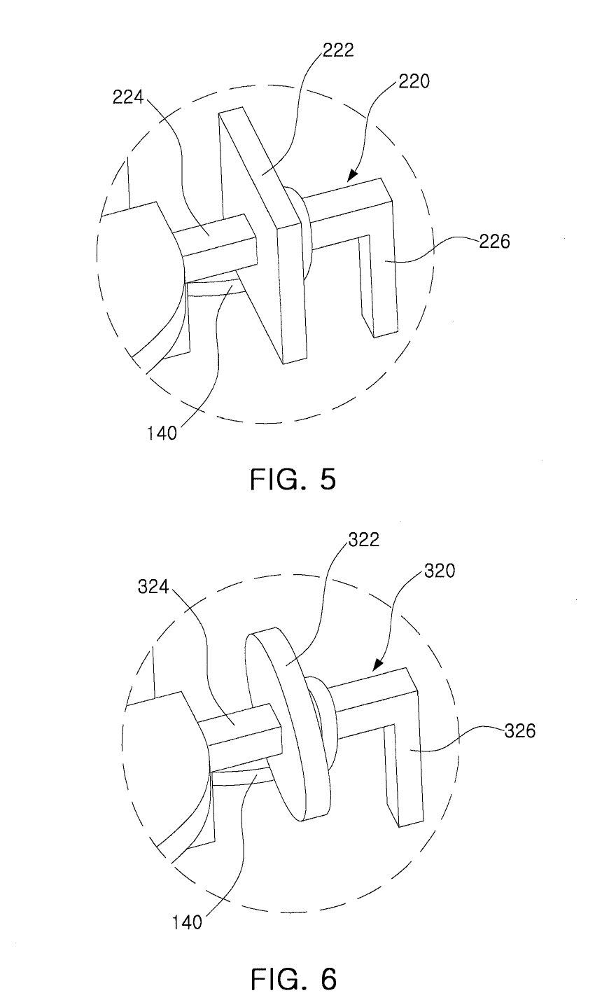

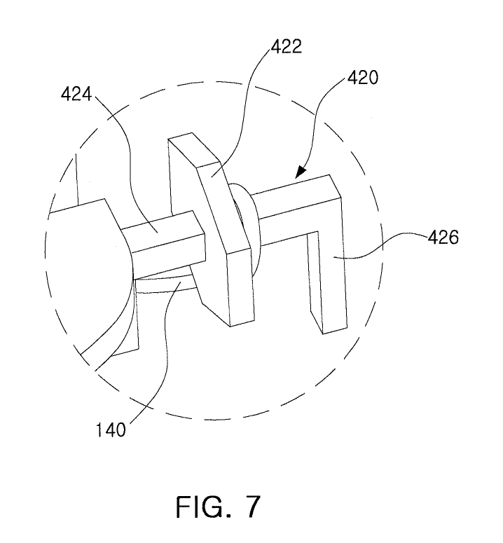

FIG. 5 is a perspective view showing an input/output terminal according to another embodiment of the present invention. FIGS. 6 and 7 are perspective views respectively showing an input/output terminal according to another embodiment of the present invention.

With reference to FIGS. 5 through 7, input/output terminals 220, 320, and 420 may include stopper portions 222, 322, and 422 for limiting a winding position such that the lead portion of the coil 140 is wound to be separated from the bobbin 110, respectively.

The input/output terminals 220, 320, and 420 may include horizontal portions 224, 324, and 424 installed in the terminal installation portion 112 such that they are parallel to the terminal installation portion 112, and bent portions 226, 326, and 426 extending from the horizontal portions 224, 324, and 424.

The stopper portions 222, 322, and 422 may extend from respective outer faces of the horizontal portions 224, 324, and 424, may be disposed to be perpendicular to the horizontal portions 224, 324, and 424, and may have any one of a circular shape, a quadrangular shape, and a polygonal shape.

Namely, the stopper portions 222, 322, and 422 may have various shapes to limit the winding position of the coil 140 such that the coil 140 is wound to be separated from the bobbin 110.

In other words, the shape of the stopper portions 222, 322, and 422 is not limited to the shapes illustrated in FIGS. 5 through 7, and the stopper portions 222, 322, and 422 may have any shape so long as it may separate the winding position of the coil 140 from the bobbin 110 and prevent the soldering solution from rising.

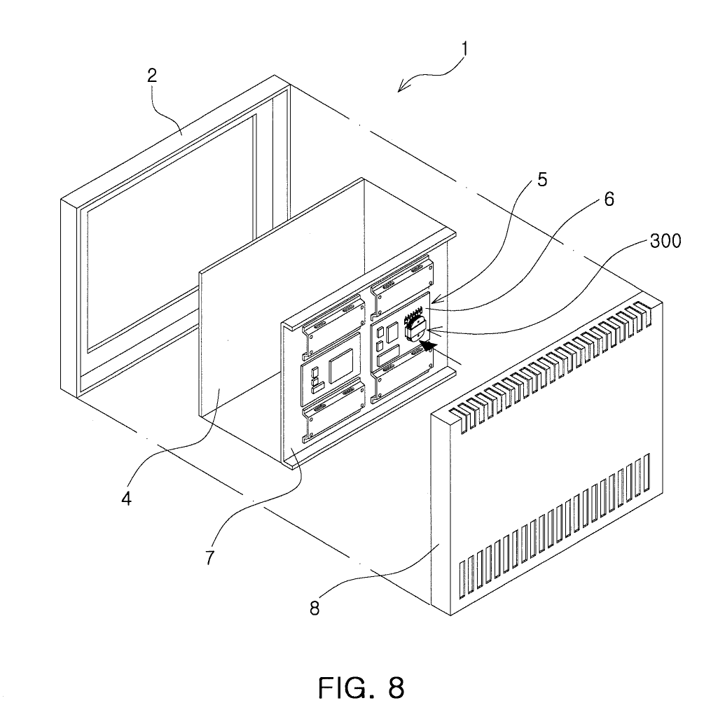

FIG. 8 is an exploded perspective view of a flat panel display device according to an embodiment of the present invention.

With reference to FIG. 8, a flat panel display device 1 according to an embodiment of the present invention may include a display panel 4, a power supply unit 5 including the transformer 100 mounted thereon, and covers 2 and 8.

The covers 2 and 8 include a front cover 2 and a back cover 8, and the front cover 2 and the back cover 8 may be coupled to form a space therein.

The display panel 4 is disposed in the internal space formed by the covers 2 and 8, and various flat display panels, such as a liquid crystal display (LCD), a plasma display panel (PDP), an organic light emitting diode (OLED), or the like, may be used as the display panel 4.

The power supply unit (or SMPS) 5 provides power to the display panel 4. The power supply unit 5 may include a plurality of electronic components mounted on a substrate 6 (e.g., a PCB), and in particular, at least one transformer 100 as described above may be mounted on the power supply unit 5.

The power supply unit 5 may be fixed to a chassis 7, and may be fixedly disposed along with the display panel 4 in the internal space formed by the covers 2 and 8.

In the transformer 100 mounted on the power supply unit 5, the coil (140 in FIG. 3) is wound to be parallel to the substrate 6 (e.g., the PCB). Also, when viewed (in a Z direction) on the plane of the substrate 6 (e.g., the PCB), the coil 140 is wound in a clockwise direction or counterclockwise direction.

When the coil 140 is wound to be parallel to the PCB 6, interference of magnetic flux generated from interaction between the transformer 100 and the exterior (e.g., the cover, or the like) may be minimized.

Thus, although the transformer 100 is mounted in a thin electronic device such as the flat panel display device 1, a generation of interference in the magnetic flux of the transformer 100 due to the back cover 8 of the flat panel display device 1 may be minimized.

Namely, a generation of noise in the flat panel display device 1 due to interference generated between the transformer 100 and the back cover 8 can be prevented.

As set forth above, according to embodiments of the invention, since a winding position at which a lead portion of a coil is wound is separated by a certain distance from a bobbin through a stopper unit, deformation of the bobbin due to a soldering solution and defective soldering caused as the coil is not immersed in the soldering solution can be reduced.

While the present invention has been shown and described in connection with the embodiments, it will be apparent to those skilled in the art that modifications and variations can be made without departing from the spirit and scope of the invention as defined by the appended claims.

What is claimed is:

1. A transformer comprising:
a bobbin, around which a coil is wound; and
an input/output terminal installed in the bobbin, a lead portion of the coil wound around the bobbin being connected to the input/output terminal,
wherein the input/output terminal has a stopper portion protruded from at least one face and limiting a winding position of the coil such that the lead portion of the coil is wound therearound to be separated from the bobbin.

2. The transformer of claim 1, wherein the bobbin has a terminal installation portion extending to be protruded from one end thereof to allow the input/output terminal to be installed therein.

3. The transformer of claim 2, wherein the input/output terminal includes a horizontal portion installed in the terminal installation portion such that the horizontal portion is parallel to the terminal installation portion, and a bent portion extending from the horizontal portion.

4. The transformer of claim 3, wherein the stopper portion extends from respective outer faces of the horizontal portion, is disposed to be perpendicular to the horizontal portion, and has any one of a circular shape, a quadrangular shape, and a polygonal shape.

5. The transformer of claim 3, wherein the stopper portion is formed as a projection extending from both side faces of the horizontal portion.

6. The transformer of claim 1, wherein the bobbin includes inner and outer bobbins, each having an annular body part having a through hole therein and a flange portion protruded from the body part to an opposite side of the through hole.

7. The transformer of claim 6, wherein the inner bobbin is inserted into the through hole of the outer bobbin so as to be coupled to the outer bobbin such that at least one of an upper surface of the flange portion of the inner bobbin and an upper surface of the flange portion of the outer bobbin, and a lower surface of the flange portion of the inner bobbin and a lower surface of the flange portion of the outer bobbin are disposed to be parallel to each other.

8. The transformer of claim 6, wherein a width of the flange portion of at least one of the inner and outer bobbins is greater than the thickness of the body part.

9. The transformer of claim 6, wherein the coil wound around the bobbin includes a primary coil wound around the inner bobbin and a secondary coil wound around the outer bobbin, and at least one of the primary coil and the secondary coil includes a plurality of coils electrically insulated from each other.

10. A flat panel display device comprising:
a power supply unit including at least one transformer of claim 1, mounted on a substrate;
a display panel receiving power from the power supply unit; and
a cover protecting the display panel and the power supply unit.

11. The flat panel display device of claim 10, wherein a coil wound in the transformer is wound to be parallel to the substrate of the power supply unit.
